(19) United States
(12) Patent Application Publication
(10) Pub. No.: US 2024/0072457 A1
(43) Pub. Date: Feb. 29, 2024

(54) TERMINAL

(71) Applicant: Yazaki Corporation, Tokyo (JP)

(72) Inventor: Yukiyoshi IKEDA, Makinohara-shi (JP)

(73) Assignee: Yazaki Corporation, Tokyo (JP)

(21) Appl. No.: 18/359,054

(22) Filed: Jul. 26, 2023

(30) Foreign Application Priority Data
Aug. 30, 2022 (JP) 2022-137010

(51) Int. Cl. H01R 4/48; H01R 4/18

(52) U.S. Cl. CPC H01R 4/48; H01R 4/185

(57) ABSTRACT

A terminal includes a tube part to which a mating terminal is inserted, a spring piece disposed in the tube part and elastically contacts the mating terminal, and a mating terminal guide part formed by forming notches on both sides of an extended portion extended from a front end of a bottom wall, and bending a portion between the notches toward the top wall side. A front end of a first corner portion where the top wall and a side wall intersect, a front end of a second corner portion where the side wall and the bottom wall intersect, a front end of a third corner portion where the bottom wall and a side wall intersect, a front end of a fourth corner portion where the side wall and the top wall intersect, and a front end of the mating terminal guide part are positioned on a same plane.

### TECHNICAL FIELD

The present invention relates to a terminal including a tube part into which a mating terminal is inserted and a spring piece disposed in the tube part.

### BACKGROUND

Conventionally, a terminal including a tube part in which a mating terminal is inserted and a spring piece disposed in the tube part, is known. Such terminal is commonly referred to as “female terminal”. FIG. 11 to FIG. 13 are diagrams showing a conventional female terminal (see Patent Document 1).

A female terminal 301 shown in FIG. 11 to FIG. 13 includes a crimping part 322 connected to an electric wire, a quadrangular tube-shaped connector part 320, and an elastic contact piece 334 disposed in the connector part 320. The connector part 320 is constituted by a bottom wall 326, side walls 328, 330 and an upper wall 332.

A front end of the bottom wall 326 is provided with a standing part 329 which is bent toward the upper wall 332 side. Notches 327 are formed on both sides of the standing part 329. One of the notches 327 is formed by cutting out a front end of a corner portion where the bottom wall 326 and one side wall 328 intersect. Another one of the notches 327 is formed by cutting out a front end of a corner portion where the bottom wall 326 and another side wall 330 intersect.

For the female terminal 301 as described above, a male terminal which is a mating terminal is inserted from an insertion opening 340 at the front end of the connector part 320 into the connector part 320 and contacts with the elastic contact piece 334 to be electrically connected to the female terminal 301.

### RELATED ART DOCUMENT

Patent Document 1: JP 2016-46175 A

### Problem to be Solved by the Invention

Since the female terminal 301 described above is provided with the notches 327, the side walls 328, 330 may be easily deformed when an external force is applied, and consequently, depending of the handling of the female terminal 301 before it is attached to a connector housing such as when crimping the terminal, there is a risk that the side walls 328, 330 are deformed. In the case when the side wall 328, 330 is deformed, there is a concern that, at the time of inserting the terminal 301 to a terminal receiving part of the connector housing, the terminal 301 interferes and cannot be inserted therein. Further, when the deformed terminal 301 is forcibly inserted, there is a concern that scraps of the connector housing may stick onto a terminal contact point and cause an electrical contact failure.

A purpose of the present invention is to provide a terminal including a quadrangular tube-shaped tube part in which strength of side walls is improved to suppress deformation of the terminal due to application of an external force.

### Solution to Problem

The present invention provides a terminal formed of a single metal plate, including a tube part in which a mating terminal is inserted, and a spring piece disposed in the tube part and configured to elastically contact with the mating terminal, wherein the tube part has a shape of a quadrangular tube including a top wall, a bottom wall, one side wall and another side wall, and is configured such that the mating terminal is inserted from an opening surrounded by a front end of the top wall, a front end of the bottom wall, a front end of the one side wall and a front end of the another side wall, wherein the terminal includes a mating terminal guide part, wherein the mating terminal guide part is formed by forming notches on both sides of an extended portion extended from the front end of the bottom wall by cutting out the front end of the bottom wall, and bending a portion between the notches toward the top wall side, and wherein a front end of a first corner portion where the top wall and the one side wall intersect, a front end of a second corner portion where the one side wall and the bottom wall intersect, a front end of a third corner portion where the bottom wall and the another side wall intersect, a front end of a fourth corner portion where the another side wall and the top wall intersect, and a front end of the mating terminal guide part are positioned on a same plane.

### Advantageous Effect of the Invention

According to the present invention, strength of the side walls is improved, and thus deformation of the terminal due to application of an external force can be suppressed.

### BRIEF DESCRIPTION OF THE DRAWINGS

FIG. 1 is a cross-sectional view of a connector including a terminal according to one embodiment of the present invention;

FIG. 2 is a diagram showing how a mating terminal is inserted into a tube part of the terminal of FIG. 1;

FIG. 3 is a perspective view of the terminal of FIG. 1;

FIG. 4 is a perspective view of the terminal of FIG. 3 viewed from another angle;

FIG. 5 is a front view of the terminal of FIG. 3;

FIG. 6 is a cross-sectional view taken along a line A-A in FIG. 5;

FIG. 7 is a cross-sectional view taken along a line B-B in FIG. 6;

FIG. 8 is a cross-sectional view taken along a line C-C in FIG. 6;

FIG. 9 is a cross-sectional view taken along a line D-D in FIG. 6;

FIG. 10 is a diagram showing a prior-to-shaping sheet chain body which is an original shape of the terminal of FIG. 3;

FIG. 11 is a side view showing a conventional female terminal;

FIG. 12 is a front view of the female terminal of FIG. 11; and

FIG. 13 is a cross-sectional view of the female terminal of FIG. 11.

### DETAILED DESCRIPTION OF THE EXEMPLARY EMBODIMENT

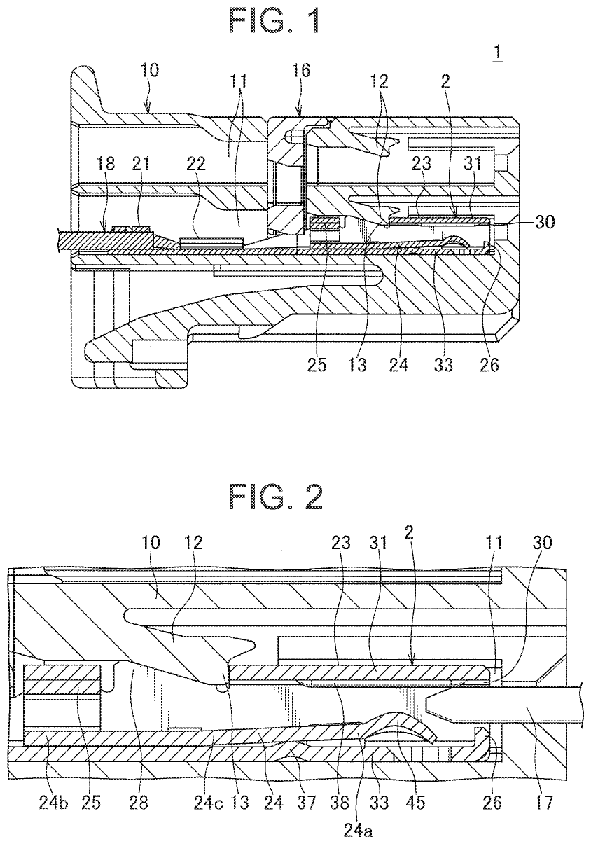

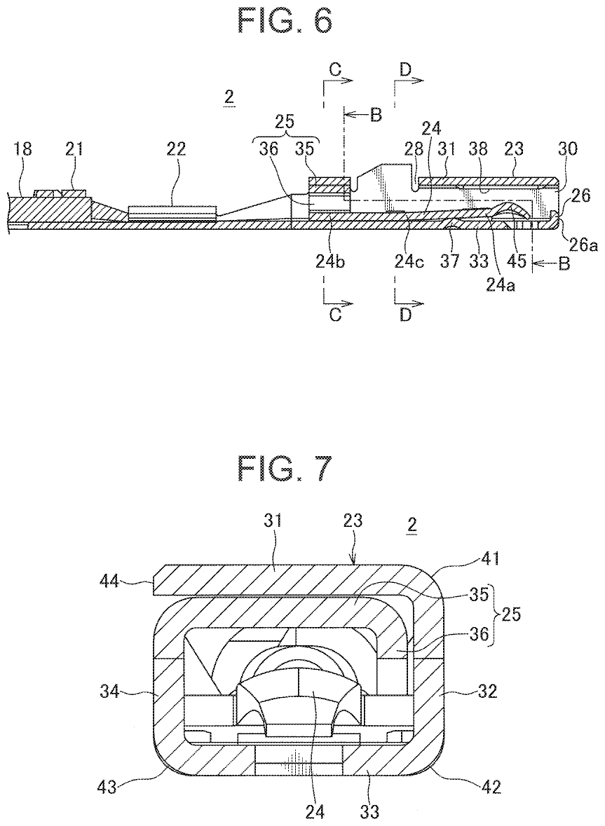

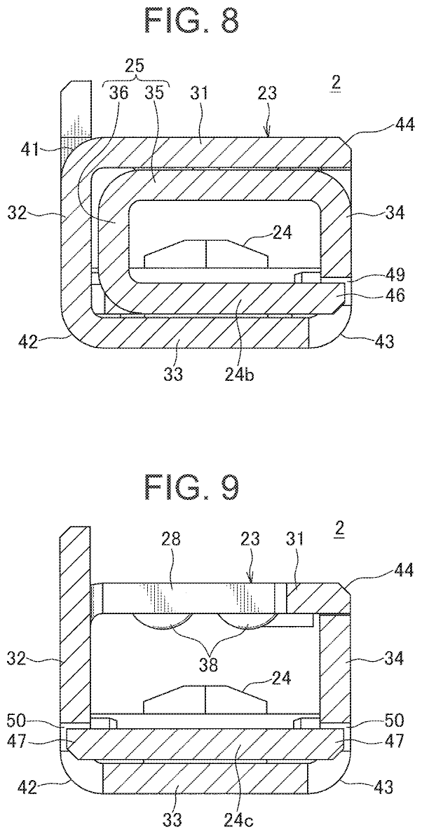

A “terminal” according to one embodiment of the present invention will be described with reference to FIG. 1 to FIG. 10.

The terminal 2 shown in FIG. 1 and FIG. 2 is connected to an end of a covered electric wire 18 and attached to a connector housing 10 to constitute a connector 1. A mating connector is fitted to the connector 1 so that a rod-shaped male terminal 17 of the mating connector (corresponding to the mating terminal) and the terminal 2 are electrically connected.

The connector housing 10 is made of an insulating synthetic resin and includes a plurality of terminal receiving parts 11 and lances 12 for locking the terminals 2 accommodated in the respective terminal receiving parts 11. The terminal 2 is inserted to the terminal receiving part 11 of the connector housing 10 with bending the lance 12, and an engagement projection 13 of the lance 12 is engaged with an engagement hole 28 of the terminal 2, thereby attaching the terminal 2 to the connector housing 10. After the insertion of the terminal 2, a spacer 16 is attached to the connector housing 10 to prevent the terminal 2 from being detached.

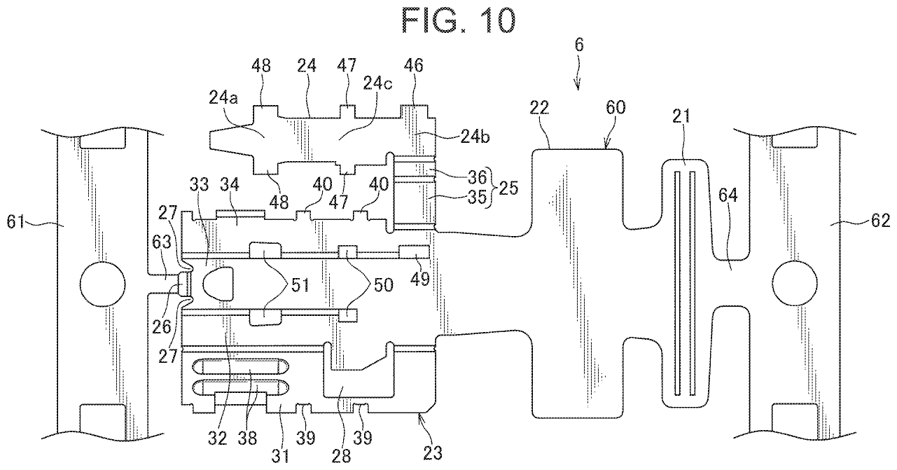

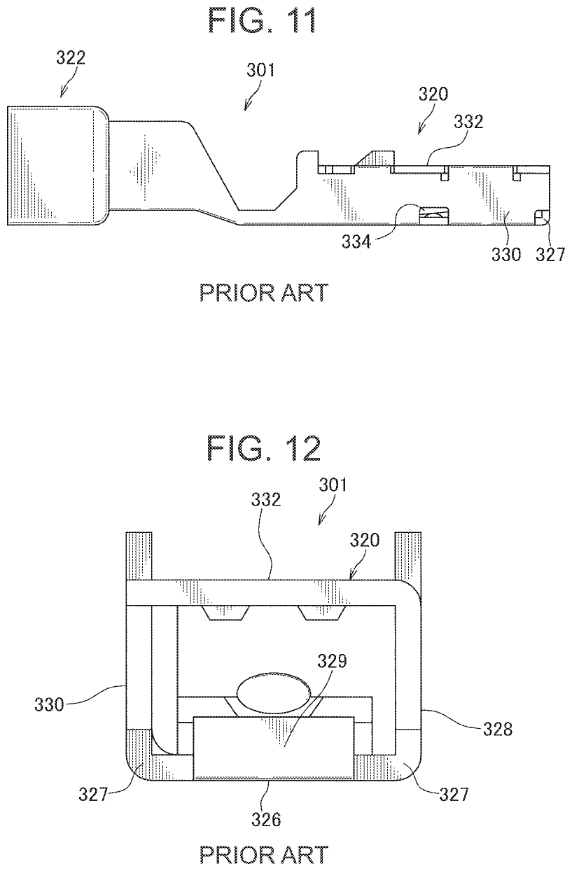

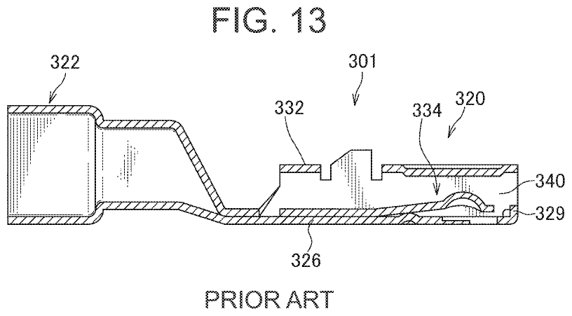

The terminal 2 is obtained by punching or bending a single metal plate. FIG. 10 shows a prior-to-shaping sheet chain body 6 which is an original shape of the terminal 2. The prior-to-shaping sheet chain body 6 includes a plurality of prior-to-shaping sheets 60 connected to two chain strips 61, 62. By bending each prior-to-shaping sheet 60 and cutting a front connection part 63 and a rear connection part 64, the terminal 2 which is separated from the prior-to-shaping sheet chain body 6 and which is in the shaped state is obtained.

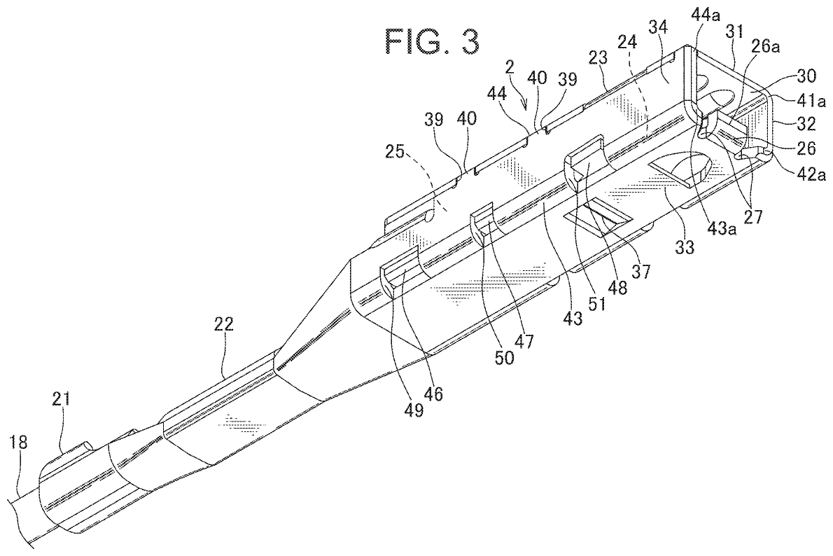

As shown in FIG. 3 to FIG. 9, the terminal 2 in the shaped state includes a cover crimping part 21, a core wire crimping part 22, a tube part 23, a spring piece 24, a connection part 25, and a mating terminal guide part 26.

The cover crimping part 21 is a portion that is crimped to a covered portion of the covered electric wire 18. The core wire crimping part 22 is a portion that is crimped to a core wire exposed portion where the cover of the covered electric wire 18 is removed and a core wire is exposed.

The tube part 23 has a shape of a quadrangular tube including a top wall 31, a bottom wall 33, one side wall 32 and another side wall 34. The male terminal 17 is inserted from an opening 30 surrounded by a front end of the top wall 31, a front end of the bottom wall 33, a front end of the one side wall 32 and a front end of the another side wall 34. The terminal 2 with the tube part 23 as described above is commonly referred to as “female terminal”.

Herein, in a longitudinal direction of the terminal 2, the covered electric wire 18 side is expressed as “rear”, and the male terminal 17 side is expressed as “front”. This front-rear direction and expressions defining a direction such as “top” and “bottom” and the like are used for convenience's sake and are not necessary to coincide with a direction in a state in which the connector 1 is actually installed to a device or the like.

The tube part 23 includes four corner portions. A corner portion where the top wall 31 and the one side wall 32 intersect is referred to as “first corner portion 41”. A corner portion where the one side wall 32 and the bottom wall 33 intersect is referred to as “second corner portion 42”. A corner portion where the bottom wall 33 and the another side wall 34 intersect is referred to as “third corner portion 43”. A corner portion where the another side wall 34 and the top wall 31 intersect is referred to as “fourth corner portion 44”.

The top wall 31 includes the engagement hole 28 with which the engagement projection 13 of the lance 12 of the connector housing 10 is engaged. Two ribs 38 are formed on the top wall 31 on a front side with respect to the engagement hole 28. These ribs 38 are formed to be concave with respect to an outer surface of the top wall 31 and convex with respect to an inner surface of the top wall 31 toward the bottom wall 33 side, and are extending parallel to each other in the front-rear direction. The male terminal 17 inserted to the tube part 23 contacts with these ribs 38.

A front portion of the top wall 31 is covered with a top wall opening prevention piece 29 which is continuous with an upper end of the another side wall 34. This prevents the top wall 31 from being opened due to vibration or an external force applied from outside, or contact load generated when the male terminal 17 is inserted.

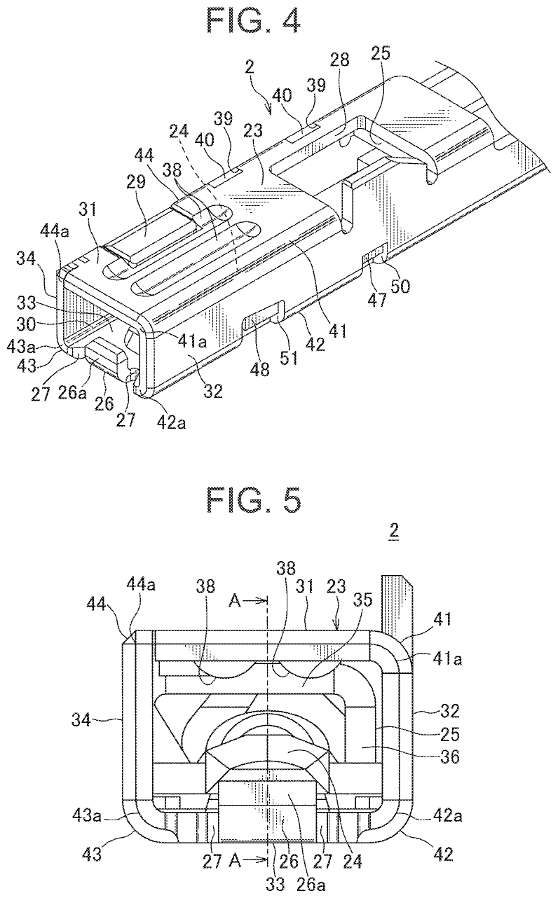

A rear portion of the top wall 31 with respect to the top wall opening prevention piece 29 is fixed, via crimping, to the side wall 34 by top wall fixing parts 40. The top wall fixing part 40 is a protruded portion protruding from the upper end of the side wall 34 as shown in FIG. 4 and FIG. 10, and the top wall fixing part 40 is configured to be strongly pushed into a recess 39 formed at an end in a width direction of the top wall 31 to fix, via crimping, the top wall 31. This prevents the top wall 31 from being damaged due to e.g., vibration transmitted thereto. The top wall fixing parts 40 and the recesses 39 are provided two, respectively.

The spring piece 24 is disposed in the tube part 23 and is configured to elastically contact with the male terminal 17. The spring piece 24 is formed in an elongated sheet shape. A rear end part 24b of the spring piece 24 is connected to a rear end part of the another side wall 34 by the connection part 25. The connection part 25 extends from the another side wall 34 toward the one side wall 32, and includes a first connection part 35 in contact with the inner surface of the top wall 31 and a second connection part 36 extending from the first connection part 35 toward the bottom wall 33. The rear end part 24b of the spring piece 24 in in contact with an inner surface of the bottom wall 33, and a front end part 24a of the spring piece 24 is a free end and is positioned in the vicinity of the opening 30.

The rear end part 24b of the spring piece 24 is provided with a projecting part 46 projecting toward the another side wall 34. The another side wall 34 includes a hole 49 to which the projecting part 46 is fitted.

The front end part 24a of the spring piece 24 includes one projecting part 48 projecting toward the one side wall 32 and another projecting part 48 projecting toward the another side wall 34. The one side wall 32 includes a hole 51 through which the one projecting part 48 is passed, and the another side wall 34 includes a hole 51 through which the another projecting part 48 is passed. With the one projecting part 48 and the another projecting part 48 passed through the respective holes 51, a movable range of the spring piece 24 is limited.

An intermediate part 24c (located between the rear end part 24b and the front end part 24a) of the spring piece 24 includes one projecting part 47 projecting toward the one side wall 32 and another projecting part 47 projecting toward the another side wall 34. The one side wall 32 includes a hole 50 to which the one projecting part 47 is fitted, and the another side wall 34 includes a hole 50 to which the another projecting part 47 is fitted.

By the projecting parts 46, 47 and the holes 49, 50, a basal portion (the rear end part 24b side) of the spring piece 24 is fixed to the tube part 23. The free end (the front end part 24a) of the spring piece 24 is configured to be displaced up and down within the movable range permitted by the projecting parts 48 and the holes 51.

A spring contact 45 which is curved in a manner convex toward the top wall 31 is formed at the front end part 24a of the spring piece 24. The bottom wall 33 includes a fulcrum protrusion 37 protruding toward the top wall 31. When the male terminal 17 is inserted in the tube part 23 and pushes the spring contact 45 toward the bottom wall 33 side, the spring piece 24 is bent, and the spring piece 24 and the male terminal 17 electrically contact with each other by a contact load with the fulcrum protrusion 37 as a fulcrum.

The mating terminal guide part 26 is formed by forming notches 27 on both sides of an extended portion extended from a front end of a bottom wall 33 by cutting out the front end of the bottom wall 33, and bending a portion between the notches 27 toward the top wall 31 side. In this example, a portion of the front connection part 63 of the prior-to-shaping sheet chain body 6 shown in FIG. 10 is used as the mating terminal guide part 26. The mating terminal guide part 26 is formed by bending the portion between the notches 27 after being separated from the prior-to-shaping sheet chain body 6. During the insertion of the male terminal 17, this mating terminal guide part 26 guides the male terminal 17 to be inserted to the tube part 23 at an appropriate angle.

In the terminal 2 of this example, a front end 41a of the first corner portion 41, a front end 42a of the second corner portion 42, a front end 43a of the third corner portion 43, a front end 44a of the fourth corner portion 44, and a front end 26a of the mating terminal guide part 26 are positioned on the same plane. That is, the notches 27 need to be formed in order to align the front end 26a of the mating terminal guide part 26 with the front ends 41a-44a of the four corner portions 41-44, but the notches 27 are formed inside these front ends of the corner portions so as to leave the front end 42a of the second corner portion 42 and the front end 43a of the third corner portion 43.

By providing walls to the front ends of the side walls 32, 34 in this way, it is possible to improve strength as compared with the conventional product, and deformation of the terminal 2 due to an external force such as impact can be suppressed. By suppressing the deformation of the terminal 2, it is possible to avoid a situation where the terminal 2 cannot be inserted to the connector housing 10. Further, because the terminal 2 is inserted without scraping the connector housing 10, electrical contact deterioration due to the scraps sticked onto the spring contact 45 can be avoided.

Further, in the terminal 2 of this example, since the connection part 25 connecting the side wall 34 and the rear end part 24b of the spring piece 24 is configured to be covered with the top wall 31 and abut on the top wall 31, the movement of the bent connection part 25 due to vibration can be suppressed by the top wall 31. This can prevent the connection part 25 from being damaged. Said vibration is, for example, vibration transmitted from the covered electric wire 18 when ultrasonically connecting the covered electric wire 18 to another electric wire. Besides the vibration, impact or an external force applied to the terminal 2 during a step of processing the terminal 2 or during transportation and processing of the covered electric wire 18 mounted with the terminal 2 may be transmitted to the spring piece 24, but it is also possible to prevent the spring piece 24 and the connection part 25 from being damaged by them.

Further, in the terminal 2 of this example, the basal portion (the rear end part 24b side) of the spring piece 24 is fixed to the tube part 23 by the projecting parts 46, 47 and the holes 49, 50. Thus, it is possible to prevent the vibration of the spring piece 24 from being transmitted to the connection part 25. Further, there is also an effect of preventing the vibration of the connection part 25 from being transmitted to the spring piece 24.

Further, in the terminal 2 of this example, since the movable range of the free end (the front end part 24a) of the spring piece 24 is limited by the projecting parts 48 and the holes 51, the spring piece 24 can be prevented from being excessively vibrating, thereby suppressing the vibration transmitted to the connection part 25.

The above-described embodiment only shows a representative form of the present invention, and the present invention is not limited to this embodiment. In other words, the present invention can be variously modified and implemented without departing from the scope of the present invention. Such modifications are, of course, within the scope of the present invention as long as they comprise the structure of the present invention.

### LIST OF REFERENCE SIGNS

2 terminal
23 tube part
24 spring piece
25 connection part
26 mating terminal guide part
27 notch
30 opening
31 top wall
32 one side wall
33 bottom wall
34 another side wall
35 first connection part
36 second connection part

What is claimed is:

1. A terminal formed of a single metal plate, comprising:
a tube part in which a mating terminal is inserted; and
a spring piece disposed in the tube part and configured to elastically contact with the mating terminal, wherein,
the tube part has a shape of a quadrangular tube including a top wall, a bottom wall, one side wall and another side wall, and is configured such that the mating terminal is inserted from an opening surrounded by a front end of the top wall, a front end of the bottom wall, a front end of the one side wall and a front end of the another side wall,
the terminal comprises a mating terminal guide part,
the mating terminal guide part is formed by forming notches on both sides of an extended portion extended from the front end of the bottom wall by cutting out the front end of the bottom wall, and bending a portion between the notches toward the top wall side, and
a front end of a first corner portion where the top wall and the one side wall intersect, a front end of a second corner portion where the one side wall and the bottom wall intersect, a front end of a third corner portion where the bottom wall and the another side wall intersect, a front end of a fourth corner portion where the another side wall and the top wall intersect, and a front end of the mating terminal guide part are positioned on a same plane.

2. The terminal according to claim 1, comprising
a connection part connecting a rear end part of the spring piece and a rear end part of the another side wall, wherein,
the connection part extends from the another side wall toward the one side wall, and includes a first connection part in contact with an inner surface of the top wall and a second connection part extending from the first connection part toward the bottom wall, and
the rear end part of the spring piece is in contact with an inner surface of the bottom wall, and a front end part of the spring piece is a free end and is positioned in vicinity of the opening.

3. The terminal according to claim 2, wherein,
the rear end part of the spring piece includes a projecting part projecting toward the another side wall, and
the another side wall includes a hole to which the projecting part is fitted.

4. The terminal according to claim 2, wherein,
the front end part of the spring piece includes one projecting part projecting toward the one side wall and another projecting part projecting toward the another side wall,
the one side wall includes a hole through which the one projecting part is passed,
the another side wall includes a hole through which the another projecting part is passed, and
with the one projecting part and the another projecting part passed through the respective holes, a movable range of the spring piece is limited.
